(19) United States
(12) Patent Application Publication
(10) Pub. No.: US 2026/0189490 A1
(43) Pub. Date: Jul. 2, 2026

(54) APPARATUS FOR AUTOMATICALLY MEASURING DELAYS AT EXTENSION SWITCH IN NETWORK ANALYZER AND METHOD THEREOF

(71) Applicant: ERANGTEK CO., LTD., Hwaseong-si Gyeonggi-do (KR)

(72) Inventors: Jae Bok LEE, Hwaseong-si, Gyeonggi-do (KR); Sang Hyo KANG, Hwaseong-si, Gyeonggi-do (KR); Yun Keun PARK, Suwon-si, Gyeonggi-do (KR); Young Nam JI, Anyang-si, Gyeonggi-do (KR); Heung Goo JEON, Siheung-si, Gyeonggi-do (KR); Dal AHN, Cheonan-si, Chungcheongnam-do (KR); Seong Ho SON, Daejeon (KR); Dong Min KIM, Yongin-si, Gyeonggi-do (KR)

(21) Appl. No.: 18/861,296

(22) PCT Filed: Sep. 15, 2023
(86) PCT No.: PCT/KR2023/013881

§ 371 Date: Oct. 29, 2024

(30) Foreign Application Priority Data
Jun. 7, 2023 (KR) 10-2023-0072704

(51) Int. Cl. H04L 43/0852; H04L 43/50

(52) U.S. Cl. CPC H04L 43/0852; H04L 43/50

(57) ABSTRACT

Embodiments relate to an apparatus for automatically measuring delays at an extension switch in a network analyzer that shortens measuring time and minimizes measurement errors by automatically optimizing the time delay between extension ports at the extension switch in the network analyzer, and shortens optimization time by automatically optimizing the time delay between the extension ports of the switch, and to a method thereof. An apparatus for automatically measuring delays at an extension switch in a network analyzer in accordance with one embodiment comprises a switch for providing at least two extension ports for test ports in the network analyzer, and a controller for controlling the network analyzer and the switch.

### FIELD OF THE INVENTION

The present invention relates to an apparatus for automatically measuring delays at an extension switch in a network analyzer, and a method thereof, so that the apparatus is allowed to automatically measure and calculate time delays between extension ports at the extension switch in the network analyzer. In addition, the present invention relates to the apparatus for automatically measuring delays at the extension switch in the network analyzer that are allowed to shorten measuring time, and minimize measurement errors by optimizing the time delay between extension ports at the extension switch, and a method thereof.

### BACKGROUND OF THE INVENTION

To commercially produce RF systems, several measuring instruments are used and they are sometimes automatically operated. Automatic or automated test equipment (ATE) means any apparatus that automatically performs tests of functions and performance of electronic devices composed of a variety of types of board assemblies by minimizing operator interventions, and identifies defective or damaged items among internal components.

Such ATE carries out tests sequentially on multiple devices or units connected with internal test resources (such as measuring instruments) through electronical interfaces based on one interconnect adaptor (ICA), and it is thus impossible to take tests on several devices subject to test.

In other words, as existing ATE can test only one device subject to test at a time, a variety of measurement instruments are required for complex electronics, and due to a lot of input and output ports subject to test, testing takes long time, which is problematic. Besides, since the development of the existing ATE is made by being optimized for each specific device subject to test, such ATE has also the problem of lack of scalability for additional devices subject to test. This have resulted in constant efforts to overcome the problems.

For an example, Korean Patent Laid-Open Publication No. 10-2015-7035504 proposed design of a signal generator that generates specific RF output signals and a vectorial network analyzer (VNA) with multiple measuring ports to allocate a RF coupler to each measuring port, and supply a specified RF output signal.

However, even in this case, it has poor efficiency of measurement due to failure in optimizing time delays between multiple ports.

### DETAILED EXPLANATION OF THE INVENTION

### Objects of the Invention

An object of the present invention is to provide an apparatus for automatically measuring delays at an extension switch in a network analyzer to shorten measuring time and minimize measurement errors by automatically optimizing the time delay between extension ports at the extension switch in the network analyzer, and a method thereof.

The other object of the present invention is to provide an apparatus for automatically measuring delays at an extension switch in a network analyzer to shorten optimization time by automatically optimizing the time delay between extension ports at the extension switch in the network analyzer, and a method thereof.

### Means of Solving the Problem

In accordance with one embodiment example of the present invention, an apparatus for automatically measuring delays at an extension switch in a network analyzer may comprise: a switch for providing at least two extension ports for test ports of the network analyzer, and a controller for controlling the network analyzer and the switch.

Herein, the controller may perform calibration of the extension ports while the network analyzer and the switch are matched with each other.

In addition, the controller may capture a reference signal image of each of individual devices under test (DUTs) for each of the extension ports by connecting the individual DUTs to the extension ports and setting time delay between the at least two extension ports to be a certain value or more.

Herein, the controller may capture a measurement signal image for each of the extension ports by connecting the individual DUTs to the extension ports and setting time delay between the at least two extension ports to be less than the certain value.

At this time, the certain value may be set to one of time delays that are allowed to be measured stably provided that multiple ports are consecutively tested at a time delay interval.

Besides, the controller may extract a difference image representing a difference between the reference signal image and the measurement signal image.

Herein, the controller may count the number of pixels of the difference image, and generate current pixel count.

Moreover, the controller may compare the current pixel count with specified decision pixel count to decide whether the measurement signal image is a normal image or not.

Herein, when decided count M190 that refers to cumulative number of deciding the measurement signal image as a normal image is less than specified normal decision count, the controller may increase the time delay as much as step delaying time, and then measure the measurement signal image again.

In addition, when decided count M190 that refers to cumulative number of deciding the measurement signal image as a normal image is equal to, or more than, the normal decision count, the controller may add up the time delay and image-converting time, and then set the time added up as an optimal time delay.

In accordance with another embodiment example of the present invention, a method of automatically measuring delays at an extension switch in a network analyzer may comprise steps of performing calibration of extension ports while the network analyzer and the switch are matched with each other; making the controller capture a reference signal image for each of the extension ports by connecting individual devices under test (DUTs) to the extension ports and setting time delay between the at least two extension ports to be a certain value or more; making the controller capture a measurement signal image for each of the extension ports by connecting the individual DUTs to the extension ports and setting time delay between the at least two extension ports to be less than the certain value; making the controller extract a difference image between the reference signal image and the measurement signal image; making the controller count the number of pixels of the difference image, and generate current pixel count; making the controller compare the current pixel count with specified decision pixel count to decide whether the measurement signal image is a normal image or not; making the controller increase the time delay as much as step delaying time, and then measure the measurement signal image again when decided count that refers to cumulative number of deciding the measurement signal image as a normal image is less than specified normal decision count; and making the controller add up the time delay and image-converting time, and then set the time added up as an optimal time delay when decided count that refers to cumulative number of deciding the measurement signal image as a normal image is equal to, or more than, the normal decision count.

At the time, the certain value may be set to one of time delays that are allowed to measure multiple ports stably provided that the multiple ports are consecutively tested at a time delay interval.

### Effects of the Invention

An apparatus for automatically measuring delays at an extension switch in a network analyzer and a method thereof in accordance with the present invention have the effects of shortening measuring time and minimizing measurement errors by optimizing the time delay between extension ports at the extension switch in the network analyzer.

Moreover, the apparatus for automatically measuring delays at the extension switch in the network analyzer and the method thereof in accordance with the present invention have the effects of shortening optimization time by automatically optimizing the time delay between extension ports at the extension switch in the network analyzer.

### BRIEF DESCRIPTION OF THE DRAWINGS

FIG. 1 is a configuration diagram of an apparatus for automatically measuring delays at an extension switch in a network analyzer in accordance with one embodiment example of the present invention.

FIG. 2 is a drawing that represents one example of wavelengths displayed on the controller in FIG. 1, where FIG. 2(a) represents a reference signal image that shows an image of a reference signal, FIG. 2(b) shows a measurement signal image that illustrates an image of a measurement signal, and FIG. 2(c) illustrates a difference image representing a difference between the reference signal image and the measurement signal image.

FIG. 3 is a drawing illustrating one example of user interface displayed on the controller in FIG. 1.

FIG. 4 is a flowchart showing a method of automatically measuring delays at an extension switch in a network analyzer in accordance with one embodiment example of the present invention.

### DETAILED DESCRIPTION OF THE PREFERRED EMBODIMENTS

Detailed examples of embodiments to implement the present invention will be explained by referring to attached drawings.

Upon the explanation of the present invention, terms such as “first,” “second,” etc. may be used to explain a variety of components but the components may not be limited by such terms. The terms are used only for the purpose of distinguishing one component from another. For example, a first component may be named as a second component without being beyond the scope of the rights of the present invention and similarly, even a second component may be named as a first one.

If it is mentioned that a component is connected or linked to another component, it may be understood that the component may be directly connected or linked to the another component but also a third component may exist in between them. The terms used in this specification are used only to explain specific examples of embodiments and they are not intended to limit the present invention. Unless a context clearly indicates a different meaning, any reference to singular may include plural ones.

In this specification, terms such as include or equip are used to indicate that there are features, numbers, steps, operations, components, parts, or combinations thereof, and it can be understood that existence or one or more different features, numbers, steps, operations, components, parts, or combinations thereof are not precluded, Besides, for clearer explanation, shapes, sizes, etc. of elements in drawings may be exaggerated.

Detailed explanation on an apparatus for automatically measuring delays at an extension switch in a network analyzer in accordance with the present invention and a method thereof will be made by referring to attached drawings.

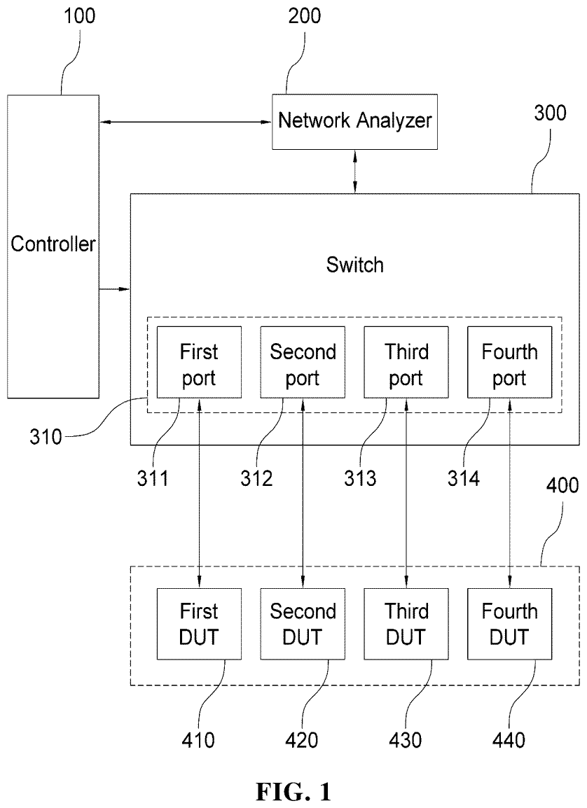

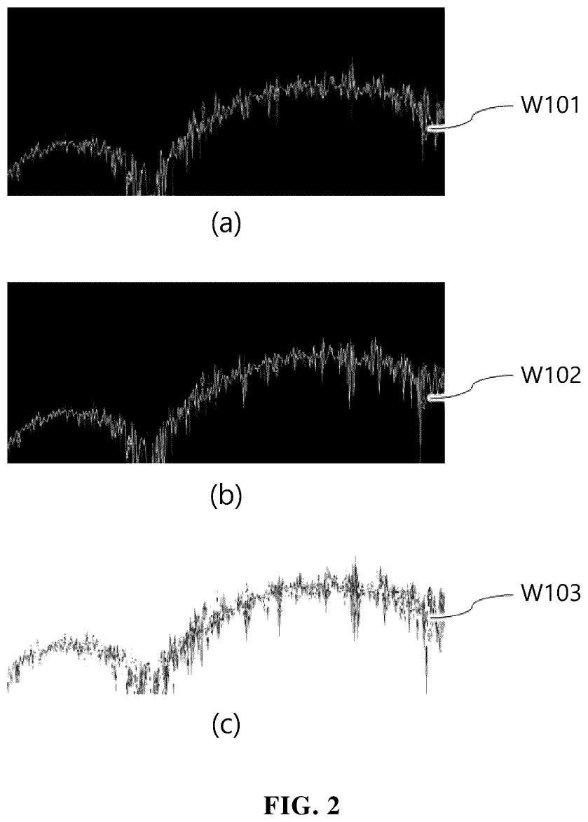

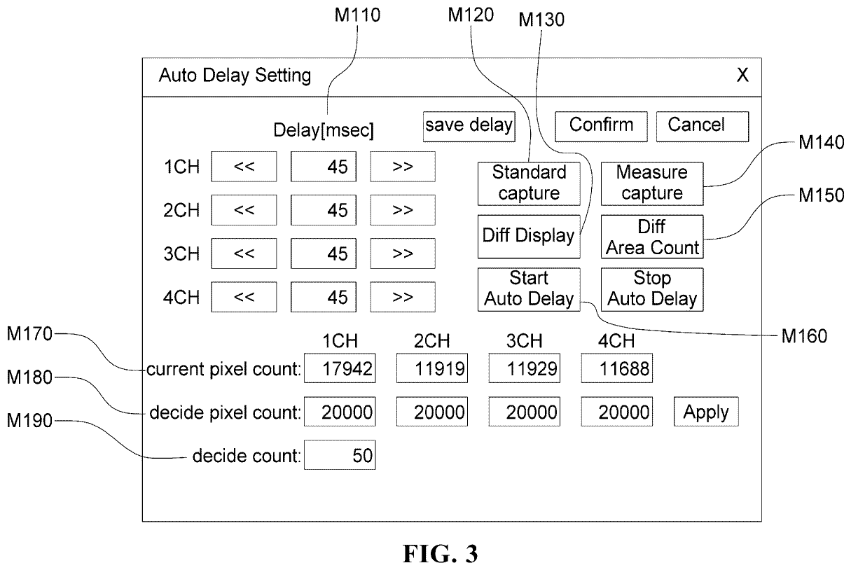

FIG. 1 is a configuration diagram of an apparatus for automatically measuring delays at an extension switch in a network analyzer in accordance with one embodiment example of the present invention, and FIGS. 2 and 3 are detailed drawings to explain in more detail.

By referring to FIGS. 1 to 3, the apparatus for automatically measuring delays at the extension switch in the network analyzer in accordance with one embodiment example of the present invention will be explained.

First, by referring to FIG. 1, the apparatus for automatically measuring delays at the extension switch in the network analyzer in accordance with one embodiment example of the present invention comprises a switch 300 for providing at least two extension ports 310 for a test port of the network analyzer 200, and a controller 100 for controlling the network analyzer 200 and the switch 300.

For example, the extension ports 310 may be provided as a first port 311, a second port 312, a third port 313, and a fourth port 314. Meanwhile, a first DUT 410, a second DUT 420, a third DUT 430, and a fourth DUT 440 as devices under test (DUTs) 400 may be matched with the extension ports 310, respectively.

Herein, to measure the DUTs 400 accurately, the controller 100 in the present invention performs calibration of the extension ports 310 while the network analyzer 200 and the switch 300 are matched for each of the extension ports 310.

Through this, the present invention can simultaneously test multiple DUTs 400 with one network analyzer 200.

Next, FIG. 2 is a drawing that represents one example of wavelengths displayed on the controller in FIG. 1, where FIG. 2(a) represents a reference signal image that shows an image of a reference signal, FIG. 2(b) shows a measurement signal image that illustrates an image of a measurement signal, and FIG. 2(c) illustrates a difference image representing a difference between the reference signal image and the measurement signal image.

As shown in FIG. 2, the controller 100 in the present invention captures a reference signal image W101 for each of the extension ports 310 by connecting the DUTs 400 to the extension ports 310 and setting time delay between the at least two extension ports 310 to be a certain value or more.

Herein, the time delay is a period of preparation to measure between multiple ports, and the reference signal image W101 represents a case where there is no measurement error due to the time delay by setting enough time delays.

Besides, the certain value may be set as one of enough time delays that are allowed to measure multiple ports stably even under various conditions provided that the multiple ports are consecutively tested at a time delay interval.

In addition, the controller 100 captures a measurement signal image W102 for each of the extension ports 310 by connecting the DUTs 400 to the extension ports 310 and setting time delay between the at least two extension ports 310 to be less than the certain value.

At the time, if a time delay for the measurement signal image W102 is less than the a certain value, a measurement error may occur due to the time delay.

In other words, for an example, if the certain value is 50 [ms], and a time delay between the extension ports 310 to measure the measurement signal image W102 is 20 [ms], a stable switching time of the switch 300 cannot be secured, and this may cause any measurement error.

In accordance with the present invention, the controller 100 may extract and analyze a difference image W103 representing a difference between the reference signal image W101 and the measurement signal image W102, and determine a measurement error and whether the measurement signal image is a normal image or not.

FIG. 2 shows a method of extracting a difference image for the measurement signal image by comparing the reference signal image and the measurement signal image, where pixels with different pixel values in RGB on the whole screen are displayed dotted in red, and a difference image extracted is created by gathering such pixel values.

After that, in accordance with the present invention, to analyze the created difference image, the number of pixels of the difference image by channel is counted, and the number of pixels which have different pixel values for each channel is also counted. In addition, when current pixel count, which refers to the number of counted pixels, is compared with specified decision pixel count, and the current pixel count is larger than the specified decision pixel count, it is decided that the measurement signal image W102 is not a normal image. This will be explained by referring to FIG. 3.

FIG. 3 is a drawing illustrating one example of user interface displayed on the controller in FIG. 1.

As seen in FIG. 3, the controller 100 in the present invention may capture a reference signal image W101 with a function of reference signal-capturing menu M120 and capture a measurement signal image W102 with a function of measurement signal-capturing menu M140.

In addition, the controller 100 extracts a difference image W103 with a function of difference signal-displaying menu M130, and counts the number of pixels of the difference image W103 with a function of difference signal area-counting menu M150 to generate current pixel count M170.

The controller 100 in the present invention compares the current pixel count M170 with specified decision pixel count M180 (e.g., 20,000 [pixels]) and decides whether the measurement signal image is a normal image or not.

Then, when decided count M190 that refers to cumulative number of deciding the measurement signal image as a normal image is less than specified normal decision count (e.g., 50 [times]), the controller 100 increases the time delay displayed in Delay between channels M110 as much as step delaying time (e.g., 5 [ms]), and then measures the measurement signal image W102 again.

Contrarily, when decided count M190 that refers to cumulative number of deciding the measurement signal image as a normal image is equal to, or more than, the normal decision count (e.g., 50 [times]), the controller 100 adds up the time delay and image-converting time, and then sets the time added up as an optimal time delay in Delay between channels M110. At the time, the present invention may allow the reference signal-capturing menu M120, the measurement signal-capturing menu M140, the difference signal-displaying menu M130, and the difference signal area-counting menu M150 to be automatically executed with a function of automatic delay-measuring menu M160 until an optimal time delay is set.

The apparatus for automatically measuring delays at the extension switch in the network analyzer in accordance with the present invention can set the optimal time delay effectively for a short period of time based on the function of the automatic delay-measuring menu M160.

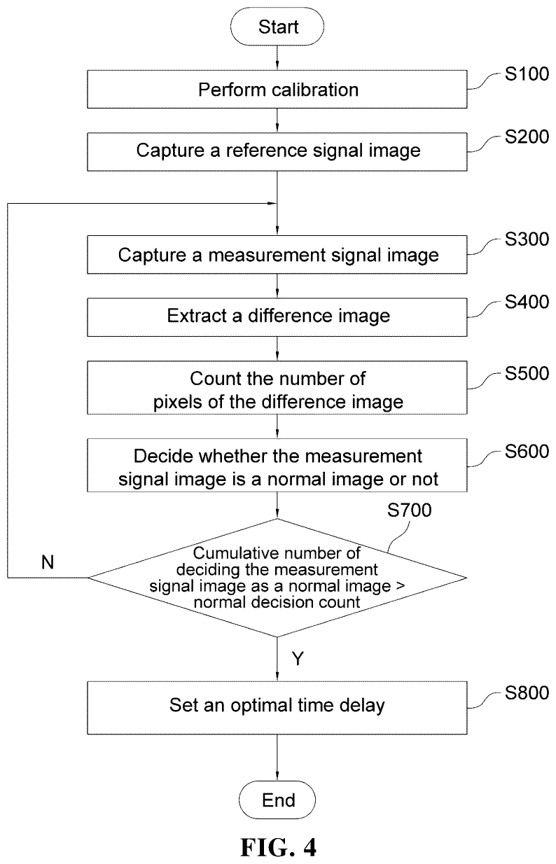

FIG. 4 is a flowchart showing a method of automatically measuring delays at an extension switch in a network analyzer in accordance with one embodiment example of the present invention.

As shown in FIG. 4, the method of automatically measuring delays at the extension switch in the network analyzer in accordance with the present invention comprises steps of: performing calibration of extension ports 310 while a network analyzer 200 and the switch 300 are matched at S100; making the controller 100 capture a reference signal image W101 for each of the extension ports 310 by connecting individual DUTs 400 to the extension ports 310 and setting time delay of the at least two extension ports 310 to be a certain value or more at S200; making the controller 100 capture a measurement signal image W102 for each of the extension ports 310 by connecting the individual DUTs 400 to the extension ports 310 and setting time delay of the at least two extension ports 310 to be less than the certain value at S300; making the controller 100 extract a difference image W103 representing a difference between the reference signal image W101 and the measurement signal image W102 at S400; making the controller 100 count the number of pixels of the difference image W103, and generate current pixel count M170 at S500; making the controller 100 compare the current pixel count M170 with specified decision pixel count M180 to decide whether the measurement signal image is a normal image or not at S600; making the controller 100 increase the time delay as much as step delaying time when decided count M190 that refers to cumulative number of deciding the measurement signal image as a normal image is less than specified normal decision count to perform the steps again from the step S300 of capturing the measurement signal image at S700; and making the controller 100 add up the time delay and image-converting time when decided count M190 that refers to cumulative number of deciding the measurement signal image as a normal image is equal to, or more than, the normal decision count to set the time added up as an optimal time delay at S800.

Herein, the time delay is a period of preparation to measure between multiple ports, and the reference signal image W101 represents a case where there is no measurement error due to the time delay by setting enough time delays at the step S200 of capturing the reference signal image.

Besides, a certain value may be set as one of enough time delays that can be allowed to measure multiple ports stably even under various conditions provided that the multiple ports are consecutively tested at a time delay interval.

Meanwhile, at the step S300 of capturing the measurement signal image, if a time delay for the measurement signal image is less than the certain value, a measurement error may occur due to the time delay.

In other words, for one example, the certain value is 50 [ms], and a time delay between the extension ports 310 to measure a measurement signal image W102 is 20 [ms], a stable switching time of the switch 300 cannot be secured, and this may cause any measurement error.

Accordingly, in accordance with the present invention, at the step S600 of deciding the measurement signal image as a normal image, a difference image W103 representing a difference between the reference signal image W101 and the measurement signal image W102 is extracted and analyzed to determine a measurement error and whether the measurement signal image is a normal image or not.

In other words, the present invention shows the method of extracting a difference image for the measurement signal image by comparing the reference signal image and the measurement signal image, and just as shown in FIG. 2, pixels with different pixel values in RGB on the whole screen may be displayed dotted in red, and a difference image extracted may be created by gathering such pixel values.

Additionally, in accordance with the present invention, to analyze the difference image, the number of pixels of the created difference image by channel is counted, and the number of pixels, which have different pixel values for each channel, is also counted. In addition, when current pixel count M170, which refers to the number of counted pixels, is compared with specified decision pixel count M180, and the current pixel count M170 is larger than the decision pixel count M180 (e.g., 20,000 [pixels]), it is decided that the measurement signal image W102 is not a normal image.

Meanwhile, as described in FIG. 3, the controller 100 in accordance with the present invention may capture a reference signal image W101 with the function of the reference signal-capturing menu M120, and capture a measurement signal image W102 with the function of the measurement signal-capturing menu M140.

In addition, the controller 100 may extract a difference image W103 with the function of the difference signal-displaying menu M130, and count the number of pixels of difference image W103 with the function of the difference signal area-counting menu M150 to generate current pixel count M170.

Meanwhile, the present invention may allow the reference signal-capturing menu M120, the measurement signal-capturing menu M140, the difference signal-displaying menu M130, and the difference signal area-counting menu M150 to be automatically executed with a function of the automatic delay-measuring menu M160 until an optimal time delay is set, and this may allow the method of automatically measuring delays at the extension switch in the network analyzer in accordance with the present invention to effectively set optimal time delay for a short period of time.

As described above, the apparatus for automatically measuring delays at the extension switch in the network analyzer and the method thereof in accordance with the present invention has the effects of shortening measuring time and minimizing measurement errors by optimizing the time delay between extension ports at the extension switch in the network analyzer, and they also have an effect of shortening optimization time by automatically optimizing the time delay between extension ports at the extension switch in the network analyzer.

Those skilled in the art will understand that a variety of exemplary logic blocks, modules, processors, means, circuits, and algorithm steps explained with respect to the examples of embodiments specified herein may be implemented by electronic hardware, various forms of programs or design codes (indicated as software herein for convenience), or combination thereof. To clearly explain interoperability between hardware and software, a variety of exemplary components, blocks, modules, circuits, and steps have been generally described with respect to their functions. Whether such functions are implemented as hardware or software or not depends on design restrictions imposed on predetermined applications and the whole system. Those skilled in the art may implement the functions of individual predetermined applications in a variety of ways, but decisions for such implementation should not be interpreted to be beyond the scope of the present invention.

A variety of examples of embodiments proposed herein may be implemented as methods, apparatuses, or manufactured articles that use standard programming and/or engineering technology. The term manufactured articles include any computer-readable storage media, accessible computer programs, carriers, or media. For example, computer-readable storage media include magnetic storage media (such as hard disks, floppy disks, magnetic strips, etc.), optical disks (such as CDs, DVDs, etc.), smart cards, and flash memory devices (such as EEPROMs, cards, sticks, key drives, etc.), but they are not limited to these. In addition, a variety of storage media suggested herein include one or more apparatuses and/or other machine-readable media to store information.

It is to be understood that the specific order or hierarchy of steps in the processes presented are examples of exemplary approaches. It is also to be understood that the specific order or hierarchy of steps in the processes within the scope of the present invention based on design priorities may be rearranged. The attached method claims provide elements of various steps in a sample order, but it is not meant that they are limited to the presented specific order or hierarchy of steps.

The description of the presented examples of embodiments is provided by those skilled in the art so that the present invention can be used or implemented. The variations and alterations of such examples of embodiments can be clearly made by those skilled in the art, and the general principles defined herein may be applied to other examples of embodiments without being beyond the scope of the present invention. Accordingly, the present invention is not limited to the examples of embodiments presented herein, but should be interpreted within the widest scope consistent with the principles and novel features disclosed herein.

### INDUSTRIAL AVAILABILITY

The present invention relates to an apparatus for automatically measuring delays at an extension switch in a network analyzer, and a method thereof, and they are available in a field of network analyzers.

1. An apparatus for automatically measuring delays at an extension switch in a network analyzer, comprising:
a switch for providing at least two extension ports for test ports of the network analyzer; and
a controller for controlling the network analyzer and the switch.

2. The apparatus of claim 1, wherein the controller performs calibration of the extension ports while the network analyzer and the switch are matched with each other.

3. The apparatus of claim 1, wherein the controller captures a reference signal image for each of the extension ports by connecting individual devices under test (DUTs) to the extension ports and setting time delay between the at least two extension ports to be a certain value or more.

4. The apparatus of claim 3, wherein the controller captures a measurement signal image for each of the extension ports by connecting the individual DUTs to the extension ports and setting time delay between the at least two extension ports to be less than the certain value.

5. The apparatus of claim 3, wherein the certain value is set to one of time delays that are allowed to measure multiple ports stably provided that the multiple ports are consecutively tested at a time delay interval.

6. The apparatus of claim 5, wherein the controller extracts a difference image representing a difference between the reference signal image and the measurement signal image.

7. The apparatus of claim 6, wherein the controller counts the number of pixels of the difference image, and generates current pixel count.

8. The apparatus of claim 7, wherein the controller compares the current pixel count with specified decision pixel count to decide whether the measurement signal image is a normal image or not.

9. The apparatus of claim 8, wherein when decided count that refers to cumulative number of deciding the measurement signal image as a normal image is less than specified normal decision count, the controller increases the time delay as much as step delaying time, and then measures the measurement signal image again.

10. The apparatus of claim 8, wherein when the decided count is equal to, or more than, the normal decision count, the controller adds up the time delay and image-converting time, and then sets the time added up as an optimal time delay.

11. A method of automatically measuring delays at an extension switch in a network analyzer, comprising steps of:
performing calibration of extension ports while the network analyzer and the switch are matched with each other;
making the controller capture a reference signal image for each of the extension ports by connecting individual devices under test (DUTs) to the extension ports and setting time delay between the at least two extension ports to be a certain value or more;
making the controller capture a measurement signal image for each of the extension ports by connecting the individual DUTs to the extension ports and setting time delay between the at least two extension ports to be less than the certain value;
making the controller extract a difference image representing a difference between the reference signal image and the measurement signal image;
making the controller count the number of pixels of the difference image, and generate current pixel count;
making the controller compare the current pixel count with specified decision pixel count to decide whether the measurement signal image is a normal image or not;
making the controller increase the time delay as much as step delaying time when decided count that refers to cumulative number of deciding the measurement signal image as a normal image is less than specified normal decision count, and then measure the measurement signal image again; and
making the controller add up the time delay and image-converting time when the decided count is equal to, or more than, the normal decision count, and then set the time added up as an optimal time delay.

12. The method of claim 11, wherein the certain value is set to one of time delays that are allowed to measure multiple ports stably provided that the multiple ports are consecutively tested at a time delay interval.

13. The apparatus of claim 4, wherein the certain value is set to one of time delays that are allowed to measure multiple ports stably provided that the multiple ports are consecutively tested at a time delay interval.
